(19) United States
(12) Patent Application Publication
(10) Pub. No.: US 2009/0152890 A1
(43) Pub. Date: Jun. 18, 2009

(54) Seat Sliding Device for Vehicles

(75) Inventor: Hyun KO, Gyunggi-Do (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/324,307

(22) Filed: Nov. 26, 2008

(30) Foreign Application Priority Data
Dec. 14, 2007 (KR) 10-2007-0131005

(51) Int. Cl. B60N 2/06; H02P 1/00

(52) U.S. Cl. 296/65.18; 297/344.1; 248/429; 318/283

(57) ABSTRACT

A seat sliding device for vehicles may include a door switch unit turned on or off in response to opening or closing of a vehicle door, a seat drive unit for causing a vehicle seat to slide rearwards when the vehicle door is opened and thus the door switch unit is turned on, a seat movement switch unit for providing a forward or rear drive signal to the seat drive unit so that the seat slides forwards or rearwards, and a control relay unit for preventing the forward drive signal from being transmitted from the seat movement switch unit to the seat drive unit by interrupting transmission of the forward drive signal when the vehicle door is in an open state.

### CROSS-REFERENCE TO RELATED APPLICATION

The present application claims priority to Korean Patent Application Number 10-2007-0131005 filed Dec. 14, 2007, the entire contents of which application is incorporated herein for all purposes by this reference.

### BACKGROUND OF THE INVENTION

1. Field of the Invention

The present invention relates generally to a control device for vehicles and, more particularly, to a seat sliding device for vehicles.

2. Description of Related Art

Conventionally, in order to ensure space suitable for the different body types of vehicle users, devices that enable users' seats to manually slide are commonly used. A representative example is a device that enables the location of a seat to be adjusted when the user of a vehicle manually manipulates an adjusting lever and a sliding lever to suit his or her body type and posture. However, conventionally, there is a disadvantage in that the user must personally manipulate the sliding device in order to change the position of a seat.

In a subsequent attempt to overcome the above-described problem, a device that enables a seat to automatically slide in response to the opening or closing of a vehicle door was proposed.

FIG. 1 is a circuit diagram of the prior art seat sliding device for vehicles. Referring to FIG. 1, the seat sliding device for vehicles includes a door switch unit 110, a seat drive unit 120, a limit switch unit 130, a seat movement switch unit 140, and a relay unit 150.

When a rear door of a vehicle is opened and thus the door switch unit 110 is turned on, the seat drive unit 120 is operated, and thus a seat slides rearwards. Subsequently, when the seat slides to a rear limit position and thus the limit switch unit 130 is turned off, the operation of the seat drive unit 120 is stopped, and thus the sliding operation of the seat is stopped.

In this state, when a forward switch is turned on through the manual manipulation of the seat movement switch unit 140 by the user of the vehicle, the seat drive unit 120 is operated, and thus the seat slides forwards. However, in this case, the vehicle door is in an open state, so that the door switch unit 110 enters an ON-state when the user removes his or her hand from the seat movement switch unit 140. As a result, the seat drive unit 120 is operated, and thus the seat slides rearwards.

Accordingly, from the point of view of the user of the vehicle, the prior art seat sliding device has a disadvantage in that, when the door is in an open state, the seat is automatically pushed rearwards even though the forward sliding of the seat is conducted, and thus it seems as though the forward movement of the seat is impeded.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a seat sliding device for vehicles, which can prevent a seat movement switch unit from being operated when a vehicle door is in an open state and to provide a seat sliding device for vehicles, which can be controlled using a simple circuit construction without performing control using a separate Electronic Control Unit (ECU) when a vehicle door is in an open state.

In an aspect of the present invention, a seat sliding device for a vehicle, may include a door switch unit turned on or off in response to opening or closing of a vehicle door, a seat drive unit for causing a vehicle seat to slide rearwards when the vehicle door is opened and thus the door switch unit is turned on, a seat movement switch unit for providing a forward or rear drive signal to the seat drive unit so that the seat slides forwards or rearwards, and/or a control relay unit for preventing the forward drive signal from being transmitted from the seat movement switch unit to the seat drive unit by interrupting transmission of the forward drive signal when the vehicle door is in an open state.

The control relay unit may interrupt the transmission of the forward drive signal to the seat drive unit by causing a switch of the control relay unit to be turned off using induced current, which is generated according to signal of the seat drive unit.

The seat sliding device may further include a limit switch unit for interrupting transmission of the forward drive signal or the rear drive signal of the seat movement switch unit to the seat drive unit while the vehicle door is opened.

The seat drive unit may be driven by a bidirectional rotary motor.

The vehicle door may be a rear door of the vehicle.

The vehicle seat may be a front seat.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a circuit diagram of a prior art seat sliding device for vehicles.

FIG. 2 is a circuit diagram of an exemplary seat sliding device for vehicles, according to the present invention.

FIG. 3 is perspective view showing an exemplary vehicle, to which a seat sliding device for vehicles according to the present invention is applied.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

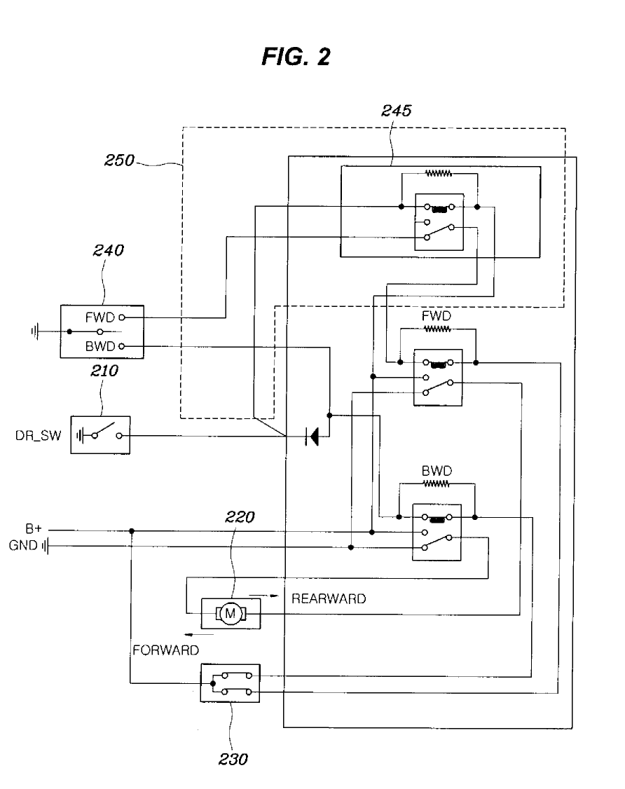

FIG. 2 is a circuit diagram of a seat sliding device for vehicles, according to various embodiments of the present invention,

Referring to FIG. 2, the seat sliding device for vehicles includes a door switch unit 210, a seat drive unit 220, a limit switch unit 230, a seat movement switch unit 240, and a relay unit 245 including a control relay unit 250.

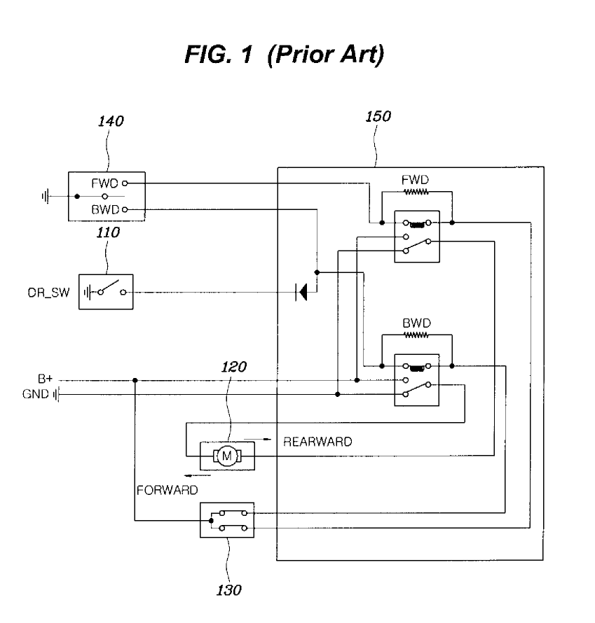

Here, the circuit of the seat sliding device is connected to the power terminal B+ of a battery. A description is given focused on the difference between the present invention and the prior art shown in FIG. 1.

The seat drive unit 220 functions to enable a vehicle seat to slide forward and rearwards. That is, the seat drive unit 220 enables the vehicle seat to slide in response to a forward or rearward drive signal of the seat movement switch unit 240.

When a rear door of a vehicle is opened, the door switch unit 210 is turned on, and thus the vehicle seat can automatically slide rearwards. A bidirectional rotary motor may be used as the above-described seat drive unit 220.

The seat movement switch unit 240 provides the forward or rear drive signal to the seat drive unit 220 so that the seat drive unit 220 can perform a forward or rearward sliding operation. The above-described forward or rear drive signal may be generated through the manipulation of a user.

When the vehicle door is in an open state, the control relay unit 250 functions to prevent the forward drive signal from being transmitted from the seat movement switch unit 240 to the seat drive unit 220 by interrupting the transmission of the forward drive signal.

The above-described operation is described in detail below.

When the vehicle door is closed, the door switch unit 210 is turned off, and thus the operation of the seat is stopped. In this case, the user can slide the seat forwards and rearwards normally by manipulating the seat movement switch unit 240.

Furthermore, when the vehicle door is opened, the door switch unit 210 is turned on and both the forward manipulation switch of the seat movement switch unit 240 and the door switch unit 210 are connected to the control relay unit 250.

Accordingly, when the door switch unit 210 is turned on, current is induced in the control relay unit 250, which is connected to the door switch unit 210, and thus the switch of the control relay unit 250, which is connected to the forward manipulation switch, is turned off. As a result, when the door is in an open state, the forward manipulation switch of the seat movement switch unit 240 is prevented from being operated by the control relay unit 250 even when the forward manipulation switch is manipulated to operate it.

In order to prevent the same drive signal from being continuously transmitted to the seat, which has slid in a single direction, the limit switch unit 230 functions to interrupt an electrical connection between a motor, which is used to drive the seat, and the seat movement switch unit 240, which is used to provide the drive signal to the motor. Accordingly, even when the drive signal is applied to the seat, which has slid, by the seat movement switch unit 240, no load is imposed on the motor for driving the seat any longer, and thus overload can be prevented from being imposed on the motor for driving the seat.

If the above-described system is not used, an electrical logic circuit, such as an ECU, must be used so that a system monitors for the condition where the door is in an open state and then control the motion of the seat. Developing such a new ECU to realize a single function causes an increase in the cost of components parts and in the investment cost. Accordingly, the problem of quality can be solved by improving existing circuits while minimally increasing the cost without developing any ECU (merely using additional relays for switch control), with the result that the effects of not only increasing the luxury image of a vehicle but also improving the image of a manufacturing company can be expected.

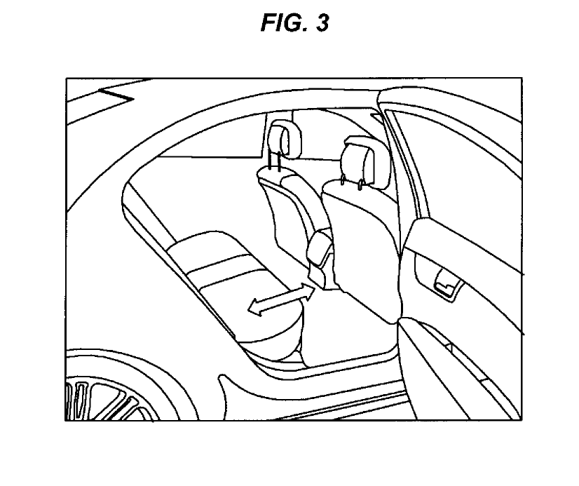

FIG. 3 is a picture showing a vehicle, to which a seat sliding device for vehicles according to various embodiments of the present invention is applied.

Referring to FIG. 3, when a vehicle door is in an open state, the control relay unit 250 interrupts the transmission of a corresponding signal in advance even when the user of a vehicle manipulates the forward manipulation switch of the seat movement switch unit 240. Accordingly, the seat can be prevented from sliding.

Detailed descriptions of other technologies for the seat sliding device for vehicles according to various embodiments of the preset invention, that is, common platform technology using an electronic system, an embedded system and an O/S, interface standardization technology using an I/O interface, and technology for standardizing components, such as an actuator and a battery, are omitted.

The seat sliding device for vehicles according to various aspects of the present invention can prevent the seat movement switch from being operated when a vehicle door is in an open state.

Furthermore, the seat sliding device for vehicles according to various aspects of the present invention can be controlled using a simple circuit construction without performing control using a separate ECU when a vehicle door is in an open state.

For convenience in explanation and accurate definition in the appended claims, the terms “rear”, “rearward”, and “forward” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A seat sliding device for a vehicle, comprising:
a door switch unit turned on or off in response to opening or closing of a vehicle door;
a seat drive unit for causing a vehicle seat to slide rearwards when the vehicle door is opened and thus the door switch unit is turned on;
a seat movement switch unit for providing a forward or rear drive signal to the seat drive unit so that the seat slides forwards or rearwards; and
a control relay unit for preventing the forward drive signal from being transmitted from the seat movement switch unit to the seat drive unit by interrupting transmission of the forward drive signal when the vehicle door is in an open state.

2. The seat sliding device as set forth in claim 1, wherein the control relay unit interrupts the transmission of the forward drive signal to the seat drive unit by causing a switch of the control relay unit to be turned off using induced current, which is generated according to signal of the seat drive unit.

3. The seat sliding device as set forth in claim 1, further comprising a limit switch unit for interrupting transmission of the forward drive signal or the rear drive signal of the seat movement switch unit to the seat drive unit while the vehicle door is opened.

4. The seat sliding device as set forth in claim 1, wherein the seat drive unit is driven by a bidirectional rotary motor.

5. The seat sliding device as set forth in claim 1, wherein the vehicle door is a rear door of the vehicle.

6. The seat sliding device as set forth in claim 1, wherein the vehicle seat is a front seat.

7. A passenger vehicle comprising the seat sliding device as set forth in claim 1.
